(19) United States
(12) Patent Application Publication
(10) Pub. No.: US 2008/0181230 A1
(43) Pub. Date: Jul. 31, 2008

(54) Remote monitoring of wellsite data

(75) Inventors: Thomas Lee Hitt, Katy, TX (US); Viendung D. Nguyen, Houston, TX (US); Wilbert Joseph Chenevert, Houston, TX (US); Thomas D. Reed, Sugarland, TX (US); Douwe Franssens, Houston, TX (US)

Correspondence Address: SCHWEGMAN, LUNDBERG & WOESSNER, P.A., P.O. BOX 2938, MINNEAPOLIS, MN, 55402, US

(73) Assignee: Halliburton Energy Services, Inc.

(21) Appl. No.: 11/824,181

(22) Filed: Jun. 29, 2007

Related U.S. Application Data
(60) Provisional application No. 60/897,426, filed on Jan. 25, 2007.

(51) Int. Cl. H04L 12/56

(52) U.S. Cl. 370/395.1

(57) ABSTRACT

In some embodiments, a method comprises receiving, at a client machine, data related to a well. The method also includes executing on the client machine, an instantiation of an application to view or manipulate the data, wherein the application is not installed on the client machine. At least one of a control, a plug-in and a runtime engine used in executing the instantiation of the application is not stored on an internal non-volatile machine-readable medium that is within the client machine.

### RELATED APPLICATION

This application claims priority to U.S. Provisional Application Ser. No. 60/897,426, filed on Jan. 25, 2007, which is incorporated herein by reference.

### TECHNICAL FIELD

The application relates generally to hydrocarbon recovery. In particular, the application relates to remote monitoring of data from a wellsite for hydrocarbon recovery.

### BACKGROUND

Monitoring and processing of wellsite data from various locations enables different users to remain apprised of the drilling, formation evaluation, completion and production operations. Such users may evaluate and make decision in real time based on this data. Alternatively or in addition, the users may retrieve the data from a remote database for monitoring and evaluation.

### BRIEF DESCRIPTION OF THE DRAWINGS

Embodiments of the invention may be best understood by referring to the following description and accompanying drawings which illustrate such embodiments. In the drawings:

FIG. 1 is a network diagram of a system for monitoring wellsite data, according to some embodiments.

FIG. 2 is a block diagram of parts of the client machine, the central server and the non-volatile machine-readable media 108 used for monitoring wellsite data, according to some embodiments.

FIG. 3 is a flow diagram for monitoring of wellsite data, according to some embodiments.

FIG. 4 illustrates a GUI screen shot for user login into the wellsite monitoring application, according to some embodiments.

FIG. 5 illustrates a GUI screen shot for selection of the various wellsites for which data can be accessed, according to some embodiments.

FIGS. 6A-6B illustrate GUI screen shots for various configurable parameters for monitoring wellsite data, according to some embodiments.

FIG. 7-10 illustrate GUI screen shots that display wellsite data from one or more wellsites, according to some embodiments.

FIG. 11 illustrates a computer that may be used for monitoring wellsite data, according to some embodiments.

FIG. 12A illustrates a drilling well during wireline logging operations, according to some embodiments.

FIG. 12B illustrates a drilling well during Measurement While Drilling (MWD) operations, Logging While Drilling (LWD) operations or Surface Data Logging (SDL) operations, according to some embodiments.

### DETAILED DESCRIPTION

Methods, apparatus and systems for remote monitoring of wellsite data are described. In the following description, numerous specific details are set forth. However, it is understood that embodiments of the invention may be practiced without these specific details. In other instances, well-known circuits, structures and techniques have not been shown in detail in order not to obscure the understanding of this description.

This description of the embodiments is divided into six sections. The first section describes a system operating environment. The second section describes an example client machine. The third section describes wellsite data monitoring operations. The fourth section describes an example computer environment. The fifth section describes wellsite operating environments. The sixth section provides some general comments.

Embodiments allow for remote monitoring of wellsite data from a client machine. The wellsite data may include various types of data that is representative of the various hydrocarbon recovery operations (e.g., drilling, formation evaluation, completion, production, etc.). For example, the wellsite data may include the downhole pressure, downhole temperatures, etc. during such operations. The wellsite data may include various characteristics of the formation (such as resistivity, porosity, pressure, etc.) during such operations. The wellsite data may also include the flowrates being pumped into the drill pipe and back up the annulus during such operations. The client machine may be located in a back office environment for various business entities (such as an oil services provider, an oil producer/distributor, etc.). The wellsite data may be collected and stored in a machine-readable medium either locally or remotely relative to the wellsite.

Some embodiments may monitor the wellsite data in real time as the operations are occurring. Alternatively or in addition, some embodiments may retrieve the data from a machine-readable medium and then monitor such data. For example, a database may store various wellsite data (such as a tracking over time of a number of wellsite parameters) during one or more operations. Therefore, a user may monitor the data for a given operation, as if the operation were occurring in realtime.

In some embodiments, an application is executable on the client machine that is non-intrusive. The application may be executed on the client machine such that the application is not installed on the client machine. Accordingly, various library functions/data are not stored on the non-volatile machine readable media (such as a hard drive) of the client machine. Moreover, because there is no installation, the system registry of the client machine is not modified (as is typical during an installation operation). The application may also be executed without controls, plug-ins or runtime engines (that are required for execution) being installed on non-removable, non-volatile machine-readable media of the client machine. For example, the application may require a particular version of a runtime engine (such as a particular version of the Java runtime engine). In some embodiments, the various library files, controls, plug-ins and runtime engines used for execution of the application may be stored on an external non-volatile machine-readable media. Examples of such media include a removable FLASH memory (such as SmartMedia cards, CompactFlash cards, etc) that is coupled to an external input/output (I/O) port of the client machine, Compact Discs (CDs), Digital Video Discs (DVDs), etc. Accordingly, in some embodiments, an application for monitoring wellsite data may be executed on various client machines without the intrusiveness typically associated with installation of applications on such machines. Thus, in some embodiments, the application is self-contained and does not require a particular browser or runtime engine on the client machine for proper execution. While described in reference to monitoring wellsite data, some embodiments may be used relative to other operations for wellsite data (such as control operations at the various wellsites).

### System Operating Environment

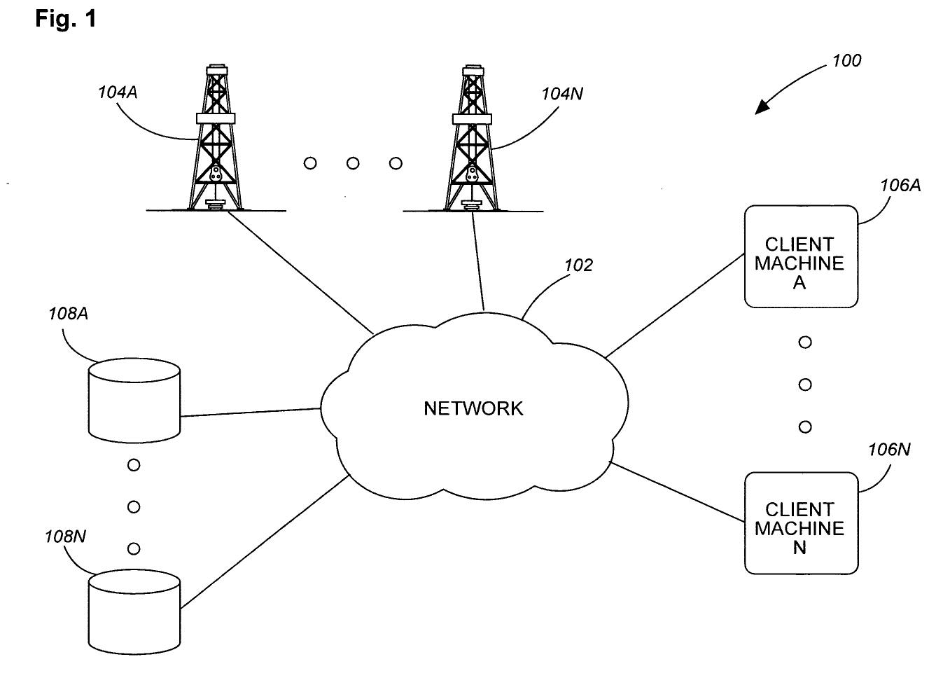

FIG. 1 is a network diagram of a system for monitoring wellsite data, according to some embodiments. A system 100 comprises a network 102 that couples together one to a number of client machines 106A-106N, one to a number of non-volatile machine-readable media 108A-108N, and one to a number of wellsites 104A-104N. The wellsites 104 may include computing devices that may collect and store the various wellsite data. For example, the computing devices may receive wellsite data from various sensors at the wellsite (including downhole and surface sensors).

The wellsite data may be replicated at one or more remote locations relative to the wellsite. For example, the computing devices at the wellsites may transmit the wellsite data to one or more of the non-volatile machine-readable media 108 and/or the client machines 106. In some embodiments, the non-volatile machine-readable media 108 may be representative of servers for storing the wellsite data therein. The network communication may be any combination of wired and wireless communication. In some embodiments, the network communication may be based on one or more communication protocols (e.g., HyperText Transfer Protocol (HTTP), HTTP Secured (HTTPS), Application Data Interface (ADI), Well Information Transfer Standard Markup Language (WITSML), etc.). A particular non-volatile machine-readable medium 108 may store data from one or more wellsites and may be stored and retrieved based on various communication protocols. The non-volatile machine-readable media 108 may include disparate data sources (such as ADI, Javi Application Data Interface (JADI), Well Information Transfer Standard Markup Language (WISTML), Log ASCII Standard (LAS), Log Information Standard (LIS), Digital Log Interchange Standard (DLIS), Well Information Transfer Standard (WITS), American Standard Code for Information Interchange (ASCII), OpenWorks, SiesWorks, Petrel, Engineers Data Model (EDM), Real Time Data (RTD), Profibus, Modbus, OLE Process Control (OPC), various wireless communication protocols (such as Code Division Multiple Access (CDMA), Global System for Mobile Communications (GSM), etc.), Video/Audio, chat, etc.). While the system 100 shown in FIG. 1 employs a client-server architecture, embodiments are not limited to such an architecture, and could equally well find application in a distributed, or peer-to-peer, architecture system.

### Example Client Machine

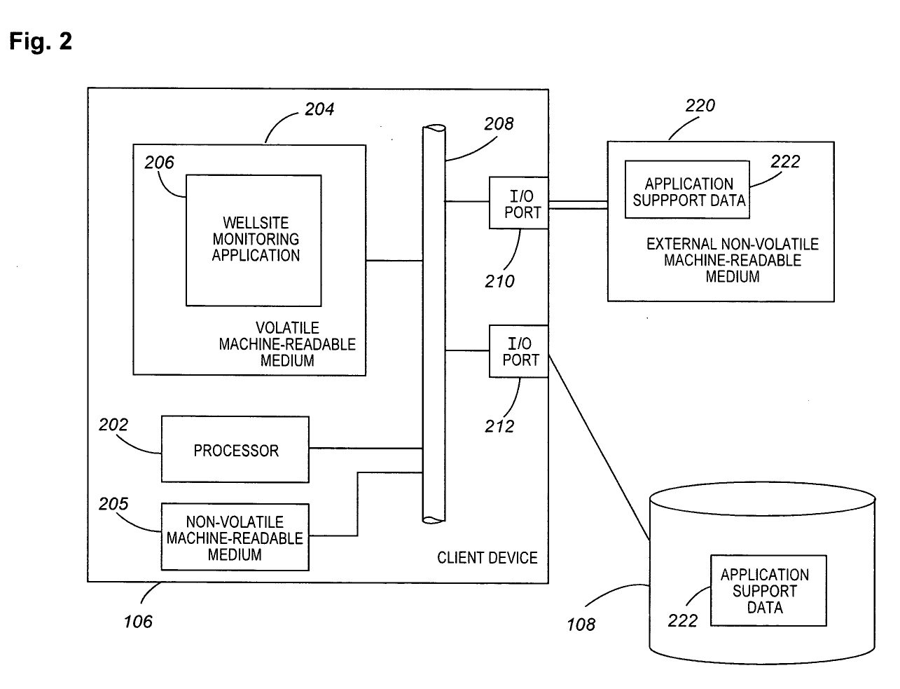

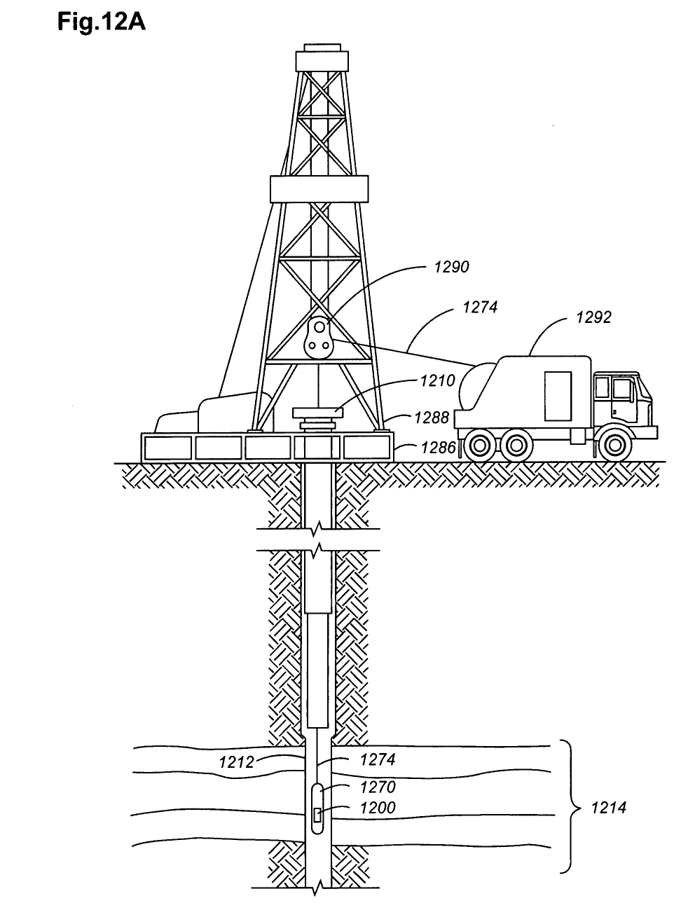

FIG. 2 is a block diagram of parts of the client machine and the non-volatile machine-readable media 108 used for monitoring wellsite data, according to some embodiments. A more detailed diagram of an example embodiment of the client machine 106 is illustrated in FIG. 11, which is described in more detail below. The client machine 106 includes a volatile machine-readable medium 204 that may store at least a part of the wellsite monitoring application 206. The client machine 106 includes a non-volatile machine readable medium 205 (e.g., magnetic disk storage media, optical storage media, FLASH memory, etc.). The client machine 106 also includes a processor 202 that may execute the wellsite monitoring application 206. The client machine 106 may also include an Input/Output (I/O) port 210 and an I/O port 212. The volatile machine-readable medium 204, the non-volatile machine-readable medium 205, the processor 202, the I/O port 210 and the I/O port 212 may communicate over a communication bus 208.

The volatile machine-readable medium 204 may be different types of Random Access Memory (RAM) (e.g., Synchronous Dynamic RAM (SDRAM), DRAM, Double Data Rate (DDR)-SDRAM, etc.). The wellsite monitoring application 206 may be stored in the volatile machine-readable medium 204, the non-volatile machine-readable medium 205 and/or internal memory (e.g., cache) of the processor.

The I/O port 210 is coupled to an external non-volatile machine readable medium 220. The non-volatile machine-readable medium 220 may be different types of non-volatile memory (such as FLASH memory), a Compact Disc (CD), a Digital Video Disc (DVD), etc. In some embodiments, the wellsite monitoring application 206 is not stored on a non-volatile machine-readable media of the client machine 106. The processor 202 may retrieve the wellsite monitoring application 206 from an external non-volatile machine-readable media (such as the external non-volatile machine-readable medium 220) for execution.

The I/O port 212 is coupled to at least one of the non-volatile machine-readable media 108. The I/O port 210 and the I/O port 212 may comprise one or more serial ports (e.g., Universal Serial Bus (USB) or FireWire), parallel ports (e.g., general purpose interface bus (GPIB) or printer port), wired network interfaces, optical interfaces, and/or wireless network interfaces, including interfaces operating according to an Institute of Electrical and Electronics Engineers (IEEE) 802.11x standard.

For more information regarding the FireWire interface, please refer to the IEEE 1394b-2002 Standard, “IEEE Standard for a High Performance Serial Bus—Amendment 2,” published in 2002, and recent revisions. For more information regarding IEEE 802.11x (e.g., IEEE 802.11g) standards, please refer to “IEEE Standards for Information Technology—Telecommunications and Information Exchange between Systems—Local and Metropolitan Area Network—Specific Requirements—Part 11: Wireless LAN Medium Access Control (MAC) and Physical Layer (PHY), ISO/IEC 8802-11: 1999,” and related amendments/revisions.

In some embodiments, the wellsite monitoring application 206 is not installed on the client machine 106. Accordingly, various library functions, files, etc. (including the application support data 222) are not populated on the non-volatile machine readable medium 205 of the client machine 106. Moreover, a system registry is not modified to reflect that the wellsite monitoring application 206 is installed on the client machine 106.

In some embodiments, application support data 222 include various functions, libraries, controls, plugins, runtime engines, etc. that may be required in the execution of the wellsite monitoring application 206. For example, various plugins may be required to display certain graphics. The wellsite monitoring application 206 may also require various executable functions or data (such as Dynamic Link Library (DLL) files). Moreover, the wellsite monitoring application 206 may require particular versions of runtime engines for execution. For example, a version of Java Runtime Engine (that may include a Java Virtual Machine, core classes, support files, etc.) may be used in the execution of the wellsite monitoring application 206.

As shown, the application support data 222 are not stored on the non-volatile machine-readable medium 205 of the client machine 106. Rather, the application support data 222 are stored on non-volatile machine readable media that is external to the client machine 106. For example, the application support data 222 may be stored on the external non-volatile machine-readable medium 220 and/or one of the non-volatile machine-readable media 108.

During execution of the wellsite monitoring application 206, various functions, files, data, etc. of the application support data 222 may be retrieved by the processor 202. Moreover, during execution, the application support data 222 may be stored in volatile machine-readable media (such as random access memory) of the client machine 106. In some embodiments, the wellsite monitoring application 222 may be distributed to the client machine 106 using a number of distribution techniques (network download, email, CD, FLASH, DVD, etc.).

### Wellsite Data Monitoring Operations

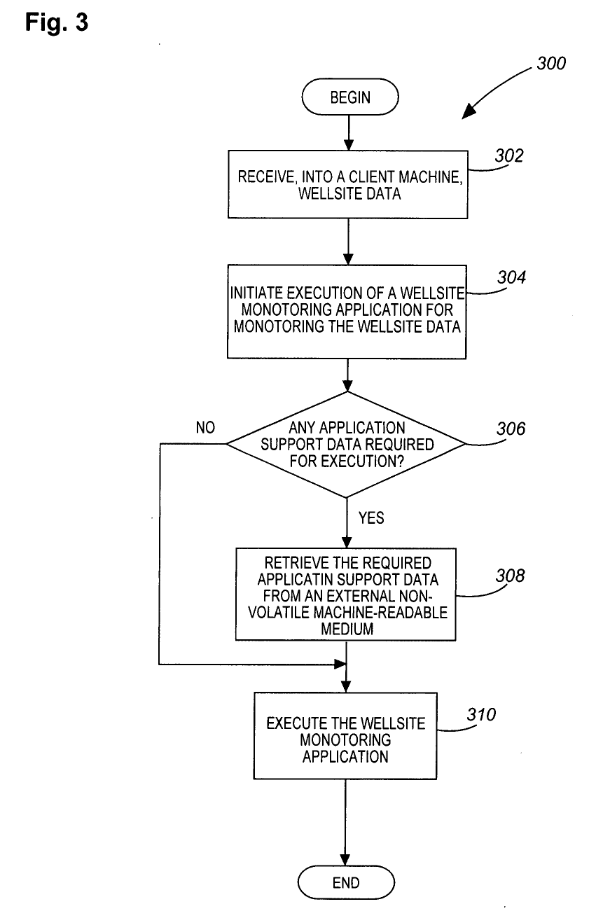

FIG. 3 is a flow diagram for monitoring of wellsite data, according to some embodiments. The flow diagram 300 is described with reference to FIGS. 1 and 2. The flow diagram 300 commences at block 302.

At block 302, wellsite data is received into a client machine. In some embodiments, the client machine 106 may receive wellsite data that is from one or more wellsites. The client machine 106 may receive wellsite data from one or more operations for a given wellsite. For example, a first set of wellsite data may be for a first drilling operation; a second set of wellsite data may be for a completion operation; a third set of wellsite data may be for a production operation, etc. The client machine 106 may receive the data in realtime as the data is being collected at one or more of the wellsites. Alternatively or in addition, the client machine 106 may receive the data from a non-volatile machine-readable media (such as one of the non-volatile machine-readable media 108). The flow continues at block 304.

At block 304, execution of a wellsite monitoring application is initiated for monitoring the wellsite data. This initiation of the execution may or may not be in response to receiving the wellsite data. For example, the wellsite data may be stored for subsequent monitoring. In some embodiments, the processor 202 may retrieve the wellsite monitoring application 206 and initiate execution. The processor 202 may retrieve the wellsite monitoring application from a local or remote machine-readable media. For example, the processor 202 may retrieve the wellsite monitoring application from the non-volatile machine-readable medium 205. The flow continues at block 306.

At block 306, a determination is made of whether any application support data are required for execution. This determination may be made at any point during execution of the wellsite monitoring application 206. In some embodiments, the processor 202 makes this determination. In particular, the wellsite monitoring application 206 is compiled such that during execution the processor 202 may determine if any application support data are needed. For example, the wellsite monitoring application 206 may include external references to various library functions, data, functionality of a runtime engine, plugins, etc. Moreover, the wellsite monitoring application 206 is compiled such that the addresses of these external references are included. Accordingly, the processor 202 may determine the addresses of these application support data. For example, in some embodiments, the external references may be to a location on the external non-volatile machine-readable medium 220 or the non-volatile machine-readable medium 108. If application support data are required, the flow continues at block 308. Otherwise, the flow continues at block 310 (which is described in more detail below).

At block 308, the required application support data are retrieved from a non-volatile machine-readable medium that is external to the client machine 106. In some embodiments, as part of the execution, the processor 202 retrieves this application support data and may temporarily store the data in volatile machine-readable media within the client machine 106. The flow continues at block 310.

At block 310, the wellsite monitoring application is executed. In some embodiments, the processor 202 performs this execution. Accordingly, as described, the wellsite monitoring application 206 may be executed without storing various support functions/data on non-volatile machine-readable media within the client machine 106. Therefore, the client machine 106 is not required to install various plugins, runtime engines, libraries, etc. prior to execution of the wellsite monitoring application 222.

In some embodiments, multiple instantiations of the wellsite monitoring application 222 may be executing simultaneously, at least in part, on the client machine 106. In some embodiments, for a given instantiation of the wellsite monitoring application 222, data from different non-volatile machine readable media may be monitored. In some embodiments, for a given instantiation of the wellsite monitoring application 222, data from different wellsites may be monitored.

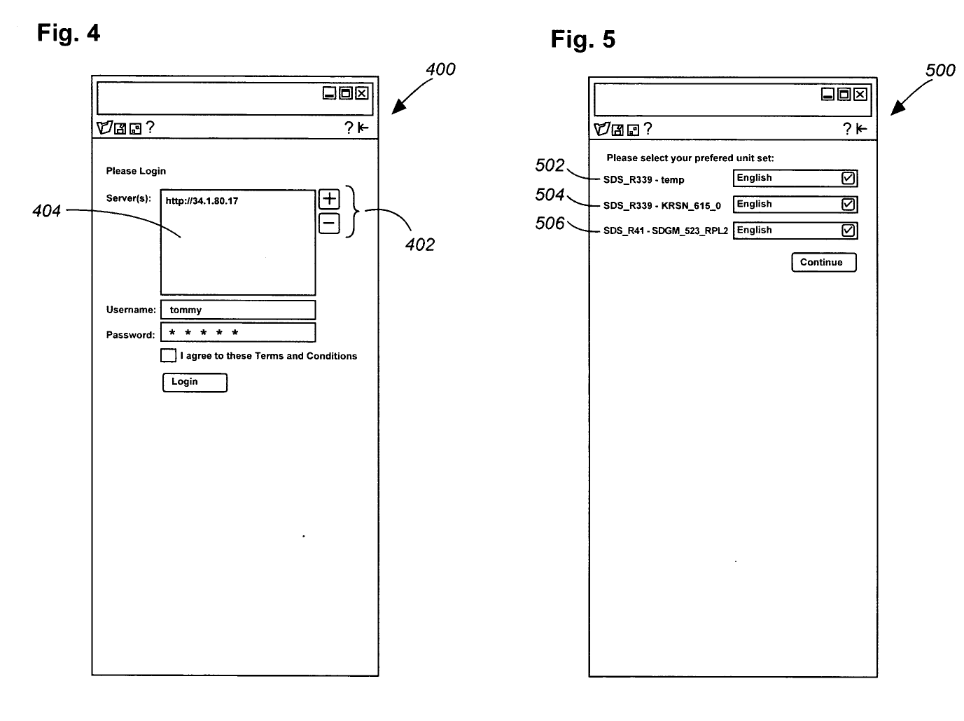

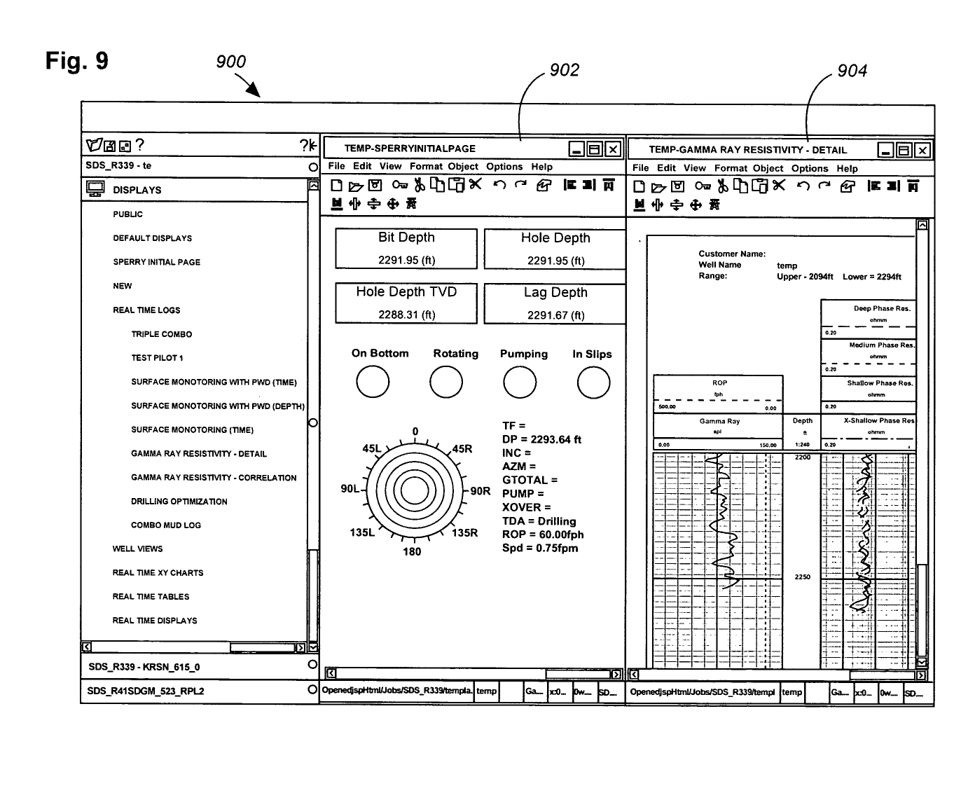

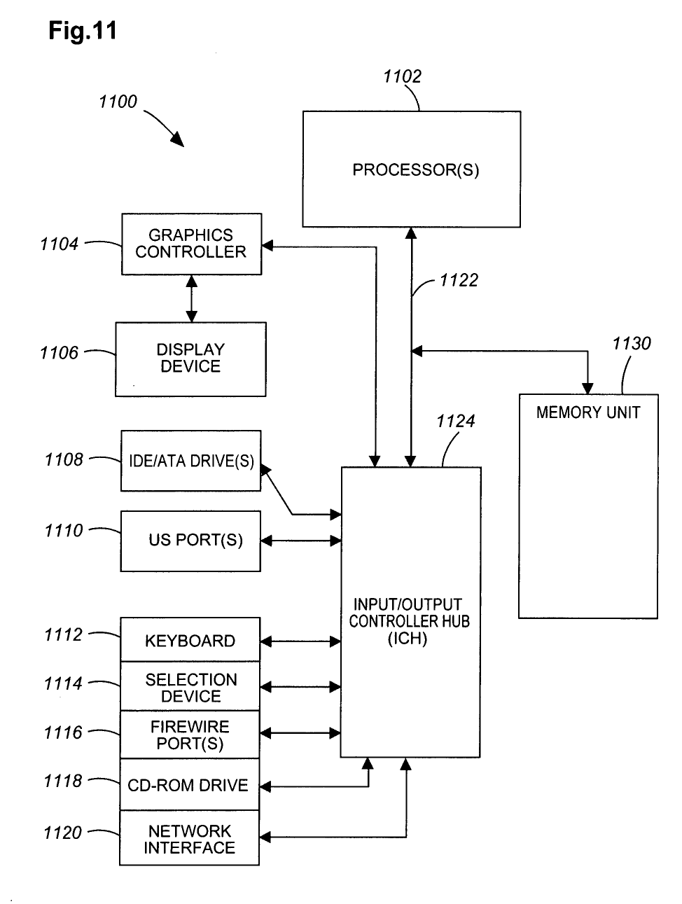

To illustrate, FIGS. 4-10 show different graphical user interface (GUI) screen shots for monitoring wellsite data, according to some embodiments. In particular, FIGS. 4-10 illustrate different GUI screen shots that may be presented on a display during execution of the wellsite monitoring application 222. FIG. 4 illustrates a GUI screen shot for user login into the wellsite monitoring application, according to some embodiments. A GUI screen shot 400 includes plus/minus buttons 402 to enable a user to add addresses (such as Internet Protocol addresses) where the wellsite data is stored. Addresses that are added are shown in section 404. Accordingly, a user may monitor wellsite data that is stored in one to any number of machine-readable media.

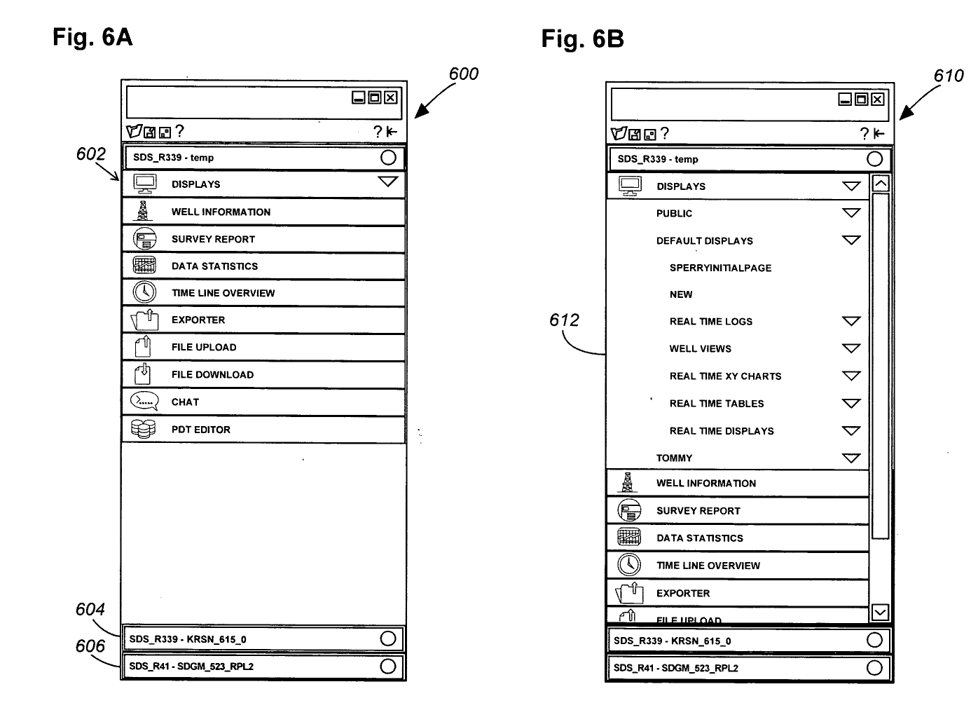

FIG. 5 illustrates a GUI screen shot for selection of the various wellsites for which data can be accessed, according to some embodiments. A GUI screen shot 500 includes sections 502, 504 and 506. Section 502 is representative of data from wellsite A. Section 504 is representative of data from wellsite B. Section 504 is representative of data from wellsite C. Accordingly, the addresses selected from GUI screen shot 400 may have data from one to a number of wellsites, which are then listed for selection in the GUI screen shot 500.

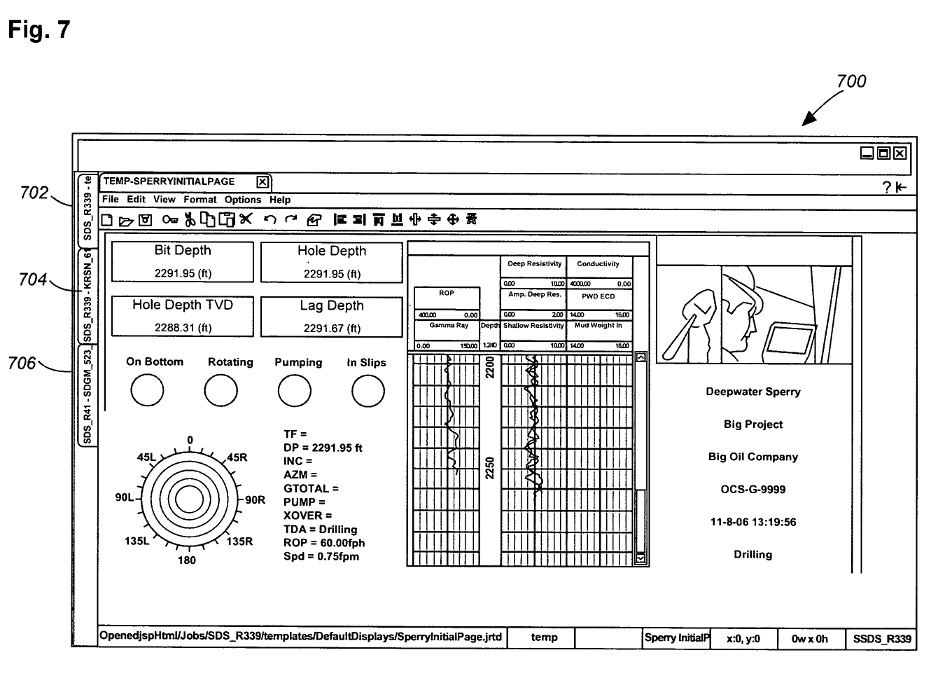

FIGS. 6A-6B illustrate GUI screen shots for various configurable parameters for monitoring wellsite data, according to some embodiments. A GUI screen shot 600 includes a section 602 for a series of parameters for wellsite A, a section 604 for a series of parameters for wellsite B, and a section 606 for a series of parameters for wellsite C. The section 602 has been selected and thus illustrates the various parameters for monitoring wellsite A. A GUI screen shot 610 illustrates the parameter for the displays can be configured (based on the types of logs, views, charts, tables, etc.). The section 602 illustrates that further parameters for a wellsite can include well information, survey report, data statistics, time line overview, exporter, file upload, file download, chat and editor. The sections 604 and 606 may be expanded (similar to section 602) for configuring parameters for wellsites B and C, respectively.

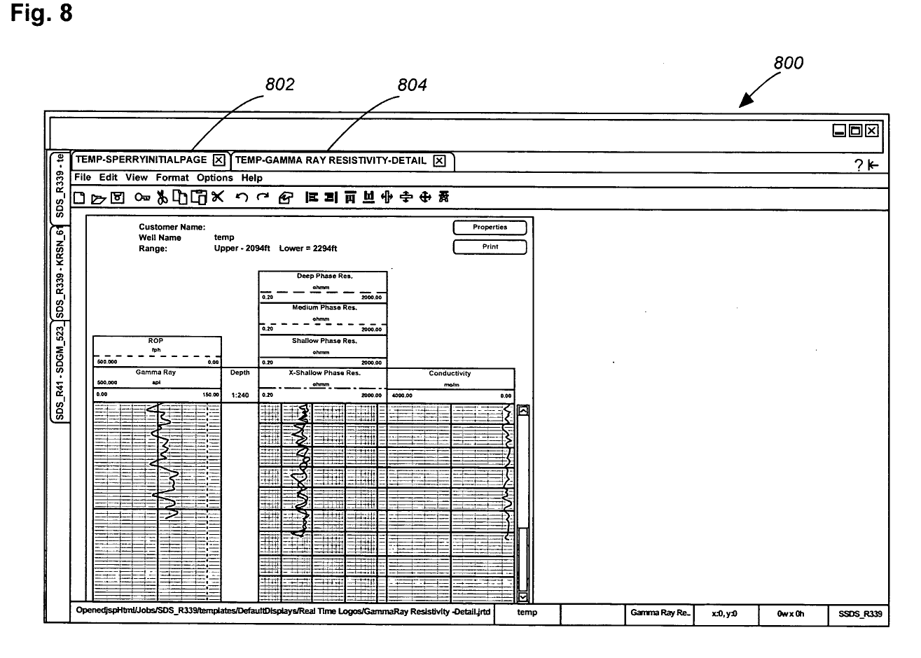

FIG. 7-10 illustrate GUI screen shots that display wellsite data from one or more wellsites, according to some embodiments. A GUI screen shot 700 illustrates that pages from more than one wellsite can be displayed based on tabbing functionality. In particular, the GUI screen shot 700 includes a tab 702, a tab 704 and a tab 706. If the tab 702 is selected, data for wellsite A may be viewed. If the tab 704 is selected, data for wellsite B may be viewed. If the tab 706 is selected, data for wellsite C may be viewed. The GUI screen shot 700 illustrates various data (e.g., bit depth, hole depth, hole depth TVD, lag depth, etc.) for wellsite A.

A GUI screen shot 800 illustrates that different pages that provide different data for a wellsite can be displayed based on tabbing functionality. In particular, the GUI screen shot 800 includes a tab 802 and a tab 804. If the tab 802 is selected, the overview page for wellsite A illustrated in the GUI screen shot 700 is shown. If the tab 804 is selected, the gamma ray resistivity data is illustrated for wellsite A.

A GUI screen shot 900 illustrates that different pages that provide different data from a wellsite can be displayed on a same screen. In particular, the GUI screen shot 900 includes a page 902 (the overview page shown on the GUI screen shot 700) and that a page 904 (the gamma ray resistivity data page shown on the GUI screen shot 800) can be shown for wellsite A on the same screen.

A GUI screen shot 1000 illustrates that different pages that provide different data from the same and different wellsites may be displayed based on a tabbing functionality. In particular, the GUI screen shot 1000 includes a tab 1002, a tab 1004 and a tab 1006. If the tab 1002 is selected, the overview page for wellsite A (shown in the GUI screen shot 700) may be viewed. If the tab 1004 is selected, the gamma ray resistivity data page for wellsite A (shown in the GUI screen shot 800) may be viewed. If the tab 1006 is selected, a well information page (as shown therein) for wellsite B may be viewed.

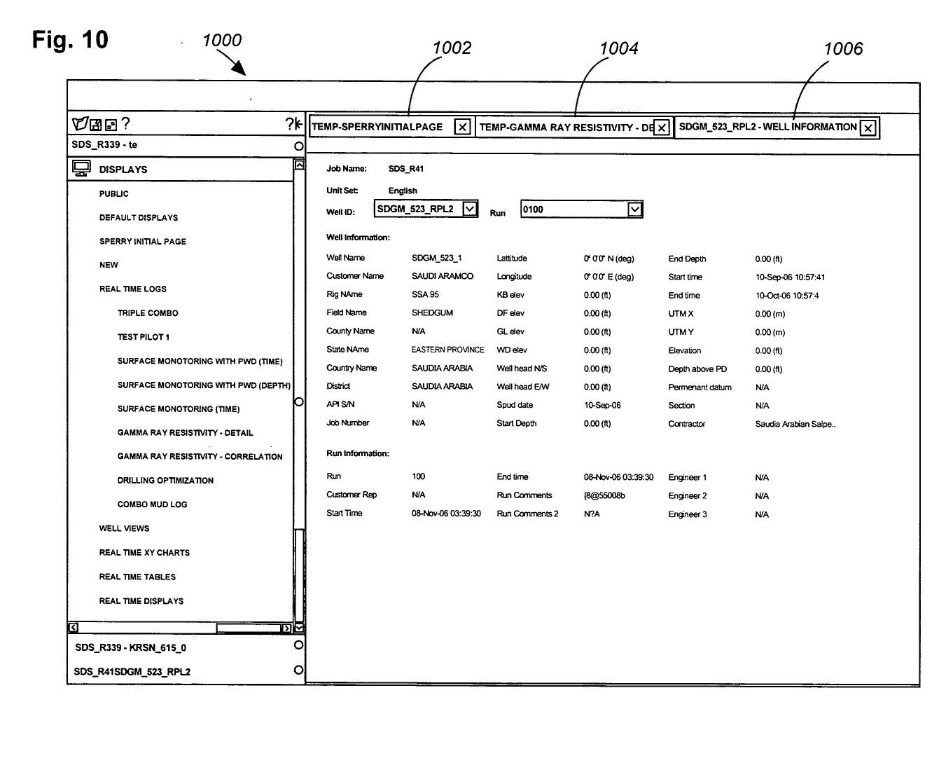

Moreover, particular embodiments allow for expansion to support other types of monitoring. In some embodiments, the well site application 206 may be modified to reference other monitoring applications. For example with reference to FIG. 9, the display includes a menu of various data that may be monitored (e.g., surface monitoring (time), gamma ray resistivity—detail, etc.). If another monitoring application is subsequently developed to monitor other types of wellsite data, the well site application 206 may be update to access this new application. Accordingly, with reference to FIG. 9, another menu item would be selectable to allow the user to monitor such data.

### Example Computer Environment

A detailed block diagram of an example computer environment, according to some embodiments, is now described. In particular, FIG. 11 illustrates a computer that may be used for monitoring wellsite data, according to some embodiments. A computer system 1100 may be representative of the client machine 106, a server that stores the non-volatile machine-readable media 108 or a local computing device at one of the wellsites 104.

As illustrated in FIG. 11, the computer system 1100 comprises processor(s) 1102. The computer system 1100 also includes a memory unit 1130, processor bus 1122, and Input/Output controller hub (ICH) 1124. The processor(s) 1102, memory unit 1130, and ICH 1124 are coupled to the processor bus 1122. The processor(s) 1102 may comprise any suitable processor architecture. The computer system 1100 may comprise one, two, three, or more processors, any of which may execute a set of instructions in accordance with embodiments of the invention.

The memory unit 1130 may store data and/or instructions, and may comprise any suitable memory, such as a dynamic random access memory (DRAM). The computer system 1100 also includes IDE drive(s) 1108 and/or other suitable storage devices. A graphics controller 1104 controls the display of information on a display device 1106, according to some embodiments of the invention.

The input/output controller hub (ICH) 1124 provides an interface to I/O devices or peripheral components for the computer system 1100. The ICH 1124 may comprise any suitable interface controller to provide for any suitable communication link to the processor(s) 1102, memory unit 1130 and/or to any suitable device or component in communication with the ICH 1124. For one embodiment of the invention, the ICH 1124 provides suitable arbitration and buffering for each interface.

For some embodiments of the invention, the ICH 1124 provides an interface to one or more suitable integrated drive electronics (IDE) drives 1108, such as a hard disk drive (HDD) or compact disc read only memory (CD ROM) drive, or to suitable universal serial bus (USB) devices through one or more USB ports 1110. For one embodiment, the ICH 1124 also provides an interface to a keyboard 1112, a mouse 1114, a CD-ROM drive 1118, one or more suitable devices through one or more firewire ports 1116. For one embodiment of the invention, the ICH 1124 also provides a network interface 1120 though which the computer system 1100 can communicate with other computers and/or devices.

In some embodiments, the computer system 1100 includes a machine-readable medium that stores a set of instructions (e.g., software) embodying any one, or all, of the methodologies for described herein. Furthermore, software may reside, completely or at least partially, within memory unit 1130 and/or within the processor(s) 1102.

### Wellsite Operating Environments

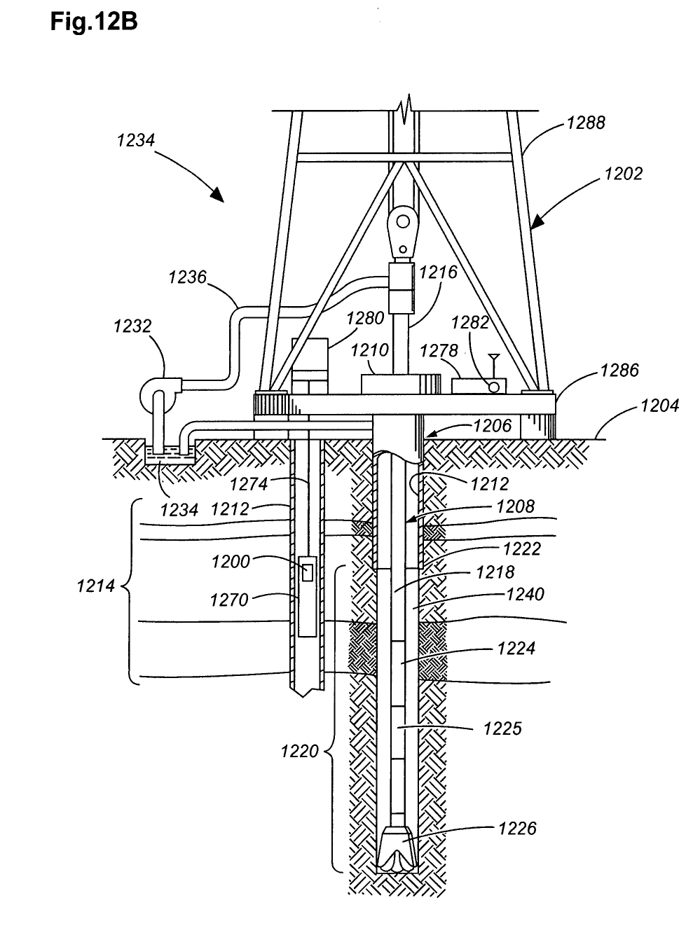

Wellsite operating environments, according to some embodiments, are now described. FIG. 12A illustrates a drilling well during wireline logging operations, according to some embodiments. A drilling platform 1286 is equipped with a derrick 1288 that supports a hoist 1290. Drilling of oil and gas wells is commonly carried out by a string of drill pipes connected together so as to form a drilling string that is lowered through a rotary table 1210 into a wellbore or borehole 1212. Here it is assumed that the drilling string has been temporarily removed from the borehole 1212 to allow a wireline logging tool body 1270, such as a probe or sonde, to be lowered by wireline or logging cable 1274 into the borehole 1212. Typically, the tool body 1270 is lowered to the bottom of the region of interest and subsequently pulled upward at a substantially constant speed. During the upward trip, instruments included in the tool body 1270 may be used to perform measurements on the subsurface formations 1214 adjacent the borehole 1212 as they pass by. The measurement data can be communicated to a logging facility 1292 for storage, processing, and analysis. The logging facility 1292 may be provided with electronic equipment for various types of signal processing. Similar log data may be gathered and analyzed during drilling operations (e.g., during Logging While Drilling, or LWD operations).

FIG. 12B illustrates a drilling well during Measurement While Drilling (MWD) operations, Logging While Drilling (LWD) operations or Surface Data Logging (SDL) operations, according to some embodiments. It can be seen how a system 1264 may also form a portion of a drilling rig 1202 located at a surface 1204 of a well 1206. The drilling rig 1202 may provide support for a drill string 1208. The drill string 1208 may operate to penetrate a rotary table 1210 for drilling a borehole 1212 through subsurface formations 1214. The drill string 1208 may include a Kelly 1216, drill pipe 1218, and a bottom hole assembly 1220, perhaps located at the lower portion of the drill pipe 1218.

The bottom hole assembly 1220 may include drill collars 1222, a downhole tool 1224, and a drill bit 1226. The drill bit 1226 may operate to create a borehole 1212 by penetrating the surface 1204 and subsurface formations 1214. The downhole tool 1224 may comprise any of a number of different types of tools including MWD (measurement while drilling) tools, LWD (logging while drilling) tools, and others.

During drilling operations, the drill string 1208 (perhaps including the Kelly 1216, the drill pipe 1218, and the bottom hole assembly 1220) may be rotated by the rotary table 1210. In addition to, or alternatively, the bottom hole assembly 1220 may also be rotated by a motor (e.g., a mud motor) that is located downhole. The drill collars 1222 may be used to add weight to the drill bit 1226. The drill collars 1222 also may stiffen the bottom hole assembly 1220 to allow the bottom hole assembly 1220 to transfer the added weight to the drill bit 1226, and in turn, assist the drill bit 1226 in penetrating the surface 1204 and subsurface formations 1214.

During drilling operations, a mud pump 1232 may pump drilling fluid (sometimes known by those of skill in the art as “drilling mud”) from a mud pit 1234 through a hose 1236 into the drill pipe 1218 and down to the drill bit 1226. The drilling fluid can flow out from the drill bit 1226 and be returned to the surface 1204 through an annular area 1240 between the drill pipe 1218 and the sides of the borehole 1212. The drilling fluid may then be returned to the mud pit 1234, where such fluid is filtered. In some embodiments, the drilling fluid can be used to cool the drill bit 1226, as well as to provide lubrication for the drill bit 1226 during drilling operations. Additionally, the drilling fluid may be used to remove subsurface formation 1214 cuttings created by operating the drill bit 1226.

### General

In the description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that embodiments of the invention may be practiced without such specific details. In other instances, control structures, gate level circuits and full software instruction sequences have not been shown in detail in order not to obscure the embodiments of the invention. Those of ordinary skill in the art, with the included descriptions will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In view of the wide variety of permutations to the embodiments described herein, this detailed description is intended to be illustrative only, and should not be taken as limiting the scope of the invention. What is claimed as the invention, therefore, is all such modifications as may come within the scope and spirit of the following claims and equivalents thereto. Therefore, the specification and drawings are to be regarded in an illustrative rather than a restrictive sense.

What is claimed is:

1. A method comprising:
receiving, at a client machine, data related to a well; and
executing on the client machine, an instantiation of an application to view or manipulate the data, wherein the application is not installed on the client machine and wherein at least one of a control, a plug-in and a runtime engine used in executing is not stored on an internal non-volatile machine-readable medium that is within the client machine.

2. The method of claim 1, wherein the at least one of the control, the plug-in and the runtime engine used in executing is stored an external non-volatile machine-readable medium or an external volatile machine-readable medium that is coupled to an external port of the client device.

3. The method of claim 2, wherein executing on the client machine comprises retrieving the at least one of the control, the plug-in and the runtime engine from the external non-volatile machine-readable medium that is coupled to the external port of the client device.

4. The method of claim 3, wherein the at least one of the control, the plug-in and the runtime engine is used in executing the instantiation of the application.

5. The method of claim 1, wherein the internal non-volatile machine-readable medium of the client device comprises a magnetic disk storage media, an optical storage media or a FLASH memory.

6. The method of claim 1, wherein a system registry of the client machine is not updated with an identification of the application.

7. The method of claim 1, wherein receiving the data is based on a communication protocol that is selected from the group consisting of Hyper Text Transfer Protocol, Hyper Text Transfer Protocol Secure, ADI and Wellsite Information Transfer Standard Markup Language

8. The method of claim 1, wherein receiving the data comprises receiving data that is from more than one well.

9. The method of claim 1, wherein receiving the data comprises receiving the data from a well over a network.

10. The method of claim 9, wherein receiving the data from the well over the network comprises receiving the data using a wireless communication.

11. The method of claim 1, wherein receiving the data comprises receiving the data from a data source that is remote from the well that is used to archive the data.

12. The method of claim 11, wherein receiving the data from the data source that is remote from the well that is used to archive the data comprises receiving the data using a wireless communication.

13. The method of claim 1, wherein data related to a well comprises at least one of data related to drilling a well and data related to a completed well.

14. A machine-readable medium including instructions which when executed by a machine causes the machine to perform operations comprising:
receiving, into a client machine that is remote from a well, well data from the well; and
initiating execution of a well monitoring application for monitoring the well data, wherein the well monitoring application is not installed on the client machine and wherein at least one of a control, a plug-in and a runtime engine used in execution of the well monitoring application is not stored on an internal non-volatile machine-readable medium that is within the client machine;
retrieving the at least one of the control, the plug-in and the runtime engine from an external non-volatile machine-readable medium; and
executing, by a processor in the client machine, an instantiation of the well monitoring application using the at least one of the control, the plug-in and the runtime engine retrieved from the external non-volatile machine-readable medium.

15. The machine-readable medium of claim 14, wherein the internal non-volatile machine-readable medium of the client device comprises a magnetic disk storage media, an optical storage media or a FLASH memory.

16. The machine-readable medium of claim 14, wherein a system registry of the client machine is not updated with an identification of the well monitoring application.

17. The machine-readable medium of claim 14, wherein receiving the well data is based on a communication protocol that is selected from the group consisting of Hyper Text Transfer Protocol, Hyper Text Transfer Protocol Secure, ADI and Wellsite Information Transfer Standard Markup Language

18. The machine-readable medium of claim 14, wherein receiving the well data comprises receiving well data that is from more than one well.

19. An apparatus comprising:
a client device comprising,
a volatile machine-readable medium to store at least part of an instantiation of an application to monitor well data related to a well activity at a well;
a non-volatile machine-readable medium to store a system registry, wherein the system registry is not updated to identify the application and wherein the application is not installed on any non-volatile machine-readable medium, including the non-volatile machine-readable medium, within the client device;
a port to communicate with an external non-volatile machine-readable medium that is to store application support data used for execution of an instantiation of the application; and
a processor to execute the instantiation of the application.

20. The apparatus of claim 19, wherein the client device is remote from the well.

21. The apparatus of claim 19, wherein the application support data is at least one of a control, a plug-in, a runtime engine and a library support function.

22. The apparatus of claim 19, wherein the processor is to retrieved the application support data from the external non-volatile machine-readable medium as part of the execution of the instantiation of the application.

23. The apparatus of claim 19, wherein the internal non-volatile machine-readable medium of the client device comprises a magnetic disk storage media, an optical storage media or a FLASH memory.

24. The apparatus of claim 19, wherein the client device is to receive the well data based on a communication protocol that is selected from the group consisting of Hyper Text Transfer Protocol, Hyper Text Transfer Protocol Secure, ADI and Wellsite Information Transfer Standard Markup Language

25. The apparatus of claim 19, wherein the client device is to receive the well data from a data source that is remote from the well.

26. The apparatus of claim 19, wherein the client device is to receive the well data from a device that is local to the well.
